(19) United States
(12) Patent Application Publication
(10) Pub. No.: US 2013/0112879 A1
(43) Pub. Date: May 9, 2013

(54) Laser Viewing System

(71) Applicant: B.E. Meyers & Co., Inc., Redmond, WA (US)

(72) Inventors: Bradley E. Meyers, Redmond, WA (US); Parry B. Johnson, Redmond, WA (US); David C. Shannon, Redmond, WA (US)

(73) Assignee: B.E. Meyers & Co., Inc., Redmond, WA (US)

(21) Appl. No.: 13/673,934

(22) Filed: Nov. 9, 2012

Related U.S. Application Data
(60) Provisional application No. 61/557,747, filed on Nov. 9, 2011.

(51) Int. Cl. G01J 5/02

(52) U.S. Cl. CPC G01J 5/02
USPC 250/341.8; 250/338.1

(57) ABSTRACT

A laser imaging system comprises a laser pointer capable of irradiating a target with energy from the laser, a filter configured to pass reflected laser radiation reflected from a target and block radiation emitted from one or more objects in the target environment, and a laser viewer capable of processing the radiation passed by the filter and generating a corresponding image.

### BACKGROUND

1. Field of the Disclosure

The present disclosure relates to a laser viewing or imaging system. The viewing system can include a viewing device to enhance vision to the unaided eye and a laser pointer. The laser pointer can be used to illuminate or direct attention to a particular area or target of interest. The invention is particularly relevant to the fields of navigation, rescue, fire fighting, surveillance, weapons deployment, or any other activity.

2. Discussion of the Related Art

FIG. 1 shows a conventional viewing system configuration known in the art. The viewing system can include a laser 10 and a viewer 30.

The laser 10 can emit any wavelength in the visible (0.38-0.75 um), near infrared (NIR, 0.75-1.3 um), short-wave infrared (SWIR, 1.3-3.0), mid-wave infrared (MWIR, 3-5 um), and long-wave infrared (LWIR, 7-14 um) spectral wavelength ranges. The laser 10 can be portable, hand-held, weapon-mounted, tri-pod mounted, or attached to any type of mount or platform. The laser 10 can be fabricated with any known laser design and manufacturing technology.

As illustrated in FIG. 1, the laser 10 emits a beam of radiation 50 directed at a target 20. The radiation beam 50 strikes the target 20 and is then reflected, absorbed, or a combination of both. FIG. 1 shows the radiation beam 50 reflecting off the target 20. However, the nature of the target 20 can cause the radiation beam 50 to scatter or separate into a series of reflected beams 55. The irradiated target 20 surface can be irregularly shaped or made of multiple materials that can contribute to variations in reflection and/or absorption. As seen in FIG. 1, the reflected beam(s) 55 is (are) directed toward a viewer 30.

The viewer 30 accepts rays of the reflected beam 55 through an input optic 60. The viewer 30 also accepts other radiation reflected or emitted 58 from the target 20 and surrounding environment. The optic 60 focuses the incoming radiation onto a detector (not shown). The incoming image that is focused on the detector can be processed by electronics and an image processor (also not shown) within the viewer and output 70 to the eye of a person in real-time or transmitted to a camera, recording device, or a device that performs data analysis prior to transmission.

A viewer based on a thermal sensor, such as a microbolometer, is particularly useful under poor visibility conditions. For example, such viewers are used during daytime or night operations when the target(s) is (are) in or near total darkness. Such thermal viewers are also capable of operating in conditions that involve smoke, smog, dust, or fog. Thermal viewers are not readily available to the general public, so they are preferred for military operations where covertness is essential to increase survivability. Accordingly, there is a need for an accompanying laser pointer in the LWIR wavelength range of 7-14 um where thermal sensors are sensitive.

Lasers for practical use as pointers are currently being developed. For example, Quantum Cascade Lasers (QCLs) are an emerging laser technology emitting in the LWIR that are not as electrically and thermally efficiency as lasers in the NIR region. In the thermal region, everything emits some energy and the current QCL pointing lasers do not have enough power to be sensed over the background of emitted energy from a lased target. Other lasers operated in visible and NIR spectrums also have the same problem. Therefore, the laser pointer must be of high enough power and/or, in multiple laser configurations, to be viewable by a viewer so that the laser reflection can be distinguished from target and local environment emissions.

Unfortunately, the high power required to operate a laser so it is a useful pointing device in certain environments necessitates a correspondingly compatible power supply. Such a power supply would result in a bulky module or battery pack to deliver the high power required. Due to inherent inefficiencies, these power devices also produce waste heat that must be thermally managed. Thus, the high laser power requirement limits the performance, battery-life, operating temperature range, robustness of use, and user visibility of certain laser technologies for pointer applications.

Safety is also a concern. There is a power threshold necessary for the laser reflection to be discerned in the viewer. The laser power necessary poses an additional concern for eye-safety. This safety hazard limits the practicality of current devices. Eye safety is highly desirable, often a necessary feature of a laser pointer, and must be considered during system design and regulatory approval.

Also, glints or back-reflections from mirror-like targets can pose a damage problem for certain detectors. The concentrated high power from laser reflections striking the viewer detector can overheat the materials formed on the detector surface and permanently damage or reduce the imaging capability of the detector.

In summary, it is highly desirable for a laser viewing system to be visible over the background radiation, be eye safe, and minimize damage to viewing detectors while reducing size, weight, and power over conventional systems. The disclosed embodiments would improve upon these needs.

### SUMMARY OF THE DISCLOSURE

Accordingly, the present disclosure is directed to a viewing or imaging system that substantially obviates one or more of the problems due to limitations and disadvantages of the related art. It can be understood by one of ordinary skill in the art that the present system can be an imaging system, but herein after referred primarily to a viewing system.

The present invention is directed to an imaging system. The imaging system comprising: a filter configured to pass reflected laser radiation reflected from a target and block radiation emitted from one or more objects in the target environment; an input optic to accept and focus the reflected laser radiation passed by the filter; a detector to receive the reflected laser radiation focused by the input optic and to convert the reflected radiation into a plurality of electronic signals; an image processing module to process the electronic signals controlled by the electronic module into image data; and an output device.

The present invention is further directed to an imaging method. The imaging method comprising the steps of: directing a viewer to a target that has been irradiated by a laser; receiving reflected radiation reflected from and emitted by the target and the target environment; filtering out a portion of the radiation received from the target and the target environment; generating image data from the filtered radiation; and outputting an image from the generated image data.

An advantage of at least one exemplary embodiment of the present invention is to provide increased visibility of a laser pointer in a viewing system.

Another advantage of at least one exemplary embodiment of the present invention is to reduce the size, weight, and power and of a laser used in a viewing system. Therefore, this advantage can correspondingly increase battery-life and reduce the thermal management constraints to simplify the design of such a device.

An even further benefit comes from allowing viewing while maintaining eye-safety and protection from reflection damage that could pose a problem regardless of the maturity of the laser technology.

Additional features and advantages of the various exemplary embodiments of the present invention will be set forth in the description which follows and, in part, will be apparent from the description, or can be learned by practice of the embodiments.

However, it is to be understood that both the foregoing general description and the following detailed description are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the invention.

In the drawings:

FIG. 1 illustrates a related art viewing system;

FIG. 2 illustrates a viewing system in accordance with exemplary embodiments of the present invention;

FIG. 3 is a block diagram illustrating various components of a viewing system in accordance with exemplary embodiments of the present invention;

FIG. 4 illustrates a spectrum filtered by a band-pass filter;

FIG. 5 is a flow chart illustrating a method of viewing an image using imaging system according to exemplary embodiments of the present invention.

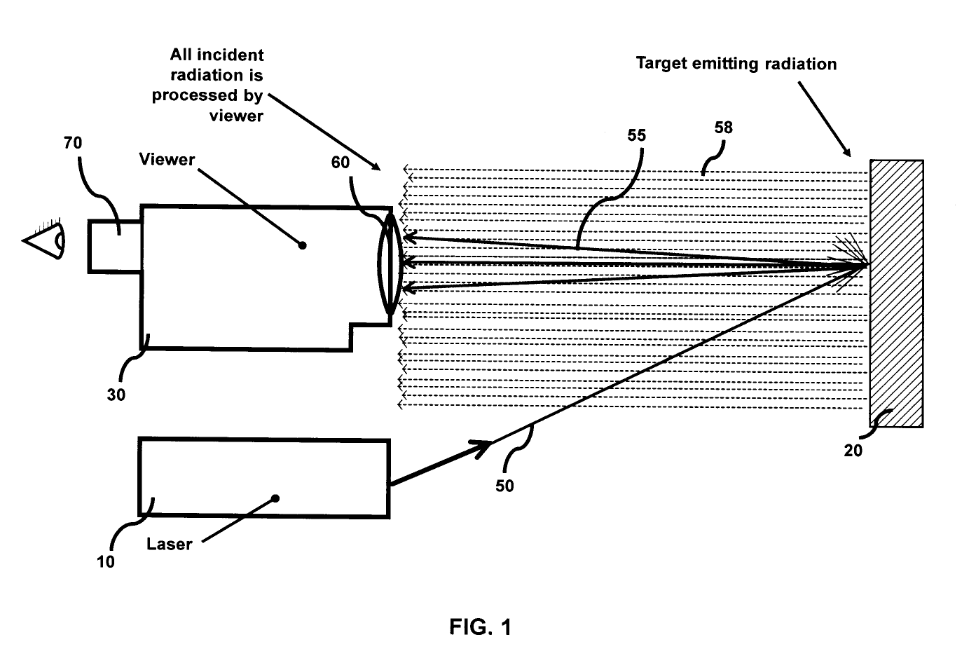

### DETAILED DESCRIPTION OF THE ILLUSTRATED EMBODIMENTS

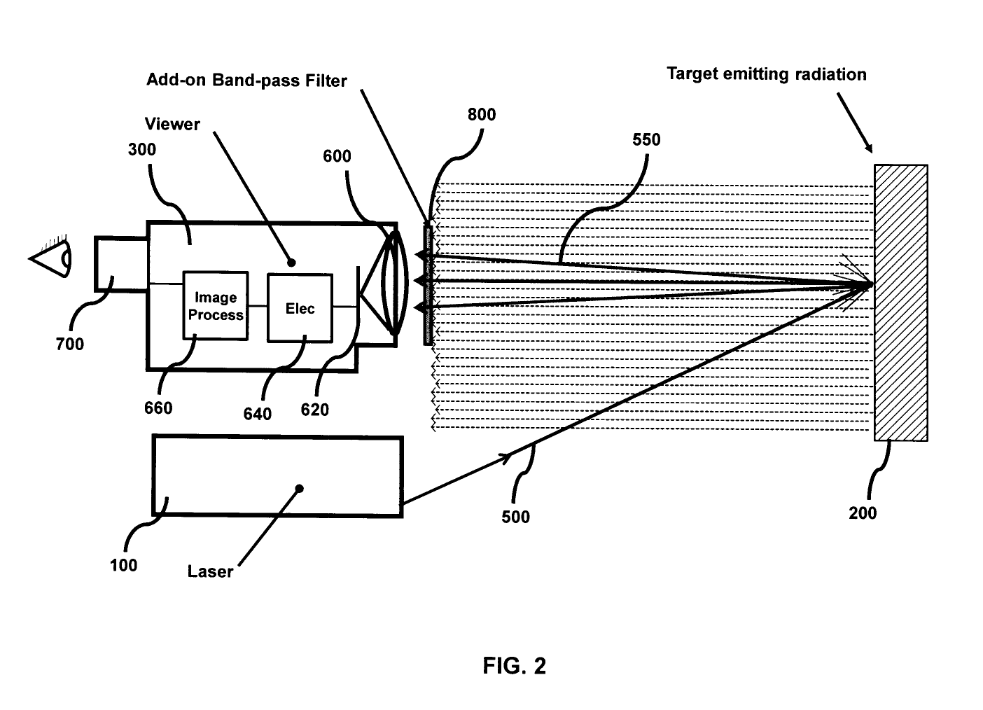

FIG. 2 illustrates a viewing system in accordance with exemplary embodiments of the present invention. The viewing system includes a laser 100, a band-pass filter 800, and a viewer 300.

As illustrated in FIG. 2, the laser 100 emits a radiation beam 500 at a target 200. The target 200 can reflect or absorb the radiation beam 500, or a combination of both. In the example of FIG. 2, the target 200 reflects the radiation beam 500. The nature of the target 200 can cause the reflected radiation beam 550 to scatter or break up into a series of reflected beams. As seen in FIG. 2, the reflected radiation beam(s) is (are) received by a viewer 300.

The reflected radiation beam 550 passes through a band-pass filter 800 prior to passing into an input optic 600 of the viewer 300. The viewer 300 accepts the reflected radiation beam(s) 550 through the input optic 600. The viewer 300 also accepts other radiation reflected or emitted from the target 200 and surrounding environment. However, only a portion of the spectrum emitted from the objects in the environment surrounding the target 200 are transmitted through the band-pass filter 800, as will be discussed in more detail below. The input optic 600 then focuses the incoming radiation onto a detector 620. The incoming image that is focused on the detector 620 can be processed by electronics 640 and an image processor 660 within the viewer and directed to an output 700 and viewed by the eye of a person in real-time. Alternatively, the image may be transmitted for remote processing and/or viewing. Other outputs could include, but are not limited to, cameras and recording devices.

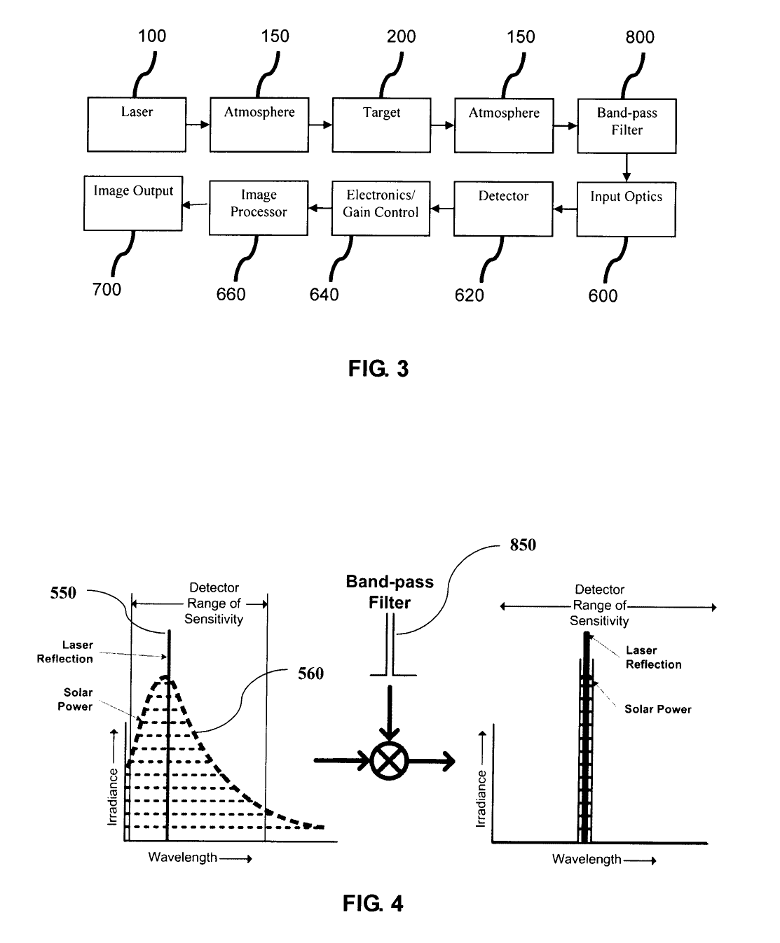

FIG. 3 shows a block diagram of a path the radiation and reflected radiation beams 500 and 550 can travel from the laser 100 to the output 700.

The laser 100 can emit any wavelength. The laser 100 can be portable, hand-held, weapon-mounted, tri-pod mounted, or attached to any type of mount or platform. There are several laser technologies that can be used to emit pointing radiations beams 500. These can include, but not limited to, a gas tube (ion) laser, a laser diode, a diode pumped solid state (DPSS) laser, and a quantum cascade laser (QCL). The laser 100 can be fabricated with any known technology.

Quantum cascade lasers (QCL) are a type of semiconductor laser that emit in the infrared range. A QCL does not rely on photons emitted across bandgaps of doped semiconductor materials as in a laser diode. A QCL is made of a series of thin layers of materials to form a superlattice with varying electric potential across the device. This leads to a series of subbands in the individual layers of varying potentials. By varying layer thicknesses it is possible to create enough energy potentials between layers to cause laser emissions. Also, the emitted wavelength can be tuned using the same material as the energy levels of the layers are determined by the layer thicknesses and not the material. A QCL device can be made small but the output laser power is low.

The radiated beam 500 can be emitted from the laser 100 into the ambient atmosphere 150 and directed toward the target 200. The reflected beam 550, or a portion thereof, is reflected by the target 200 back into the atmosphere 150 and, as previous described, scattered or separated into separate beams. The scattered or separated beams then propagate toward the viewer 300.

Further shown in FIG. 3, the reflected radiation beam 550 travels through a band-pass filter 800 prior to entering the input optic 600. The band-pass filter 800 geometry can be any configuration that is compatible with the viewer 300. The band-pass filter 800 can be made from any combination of substrate materials and thin film coatings suitable to block or minimize portions of the radiation emitted from the target 200 or background scene while passing the wavelength of the reflected radiated beam 550. The band-pass filter 800 can be angle-tuned to match the laser 100 wavelength. Thus, the band-pass filter 800 restricts the ambient energy from entering the viewer 300 while allowing radiation of the reflected radiation beam 550 to pass and enter the viewer, as further described below. In the resulting image, the target 200 irradiated by the radiation beam 500 will appear brighter than the background environment.

Thus, the band-pass filter 800 increases the contrast between the target 200 and the objects in the surrounding environment in the resulting image. The contrast being the visual difference between the light areas and the dark areas of the image. Contrast (C1) is calculated as C1=(Pb−Pd)/(Pb+Pd), where Pb=bright areas, Pd=dark areas (background). Contrast in this context is a measure of the difference between the irradiated target and its background. A high contrast is desirable for a user to discern the target 200. A laser 100 on target 200 will produce an output image brightness. However, if the surrounding background has the exact same displayed brightness, the irradiated target will be imperceptible.

One practical system benefit is that the band-pass filter 800 reduces the laser power requirement for a given laser/viewer combination. Another benefit is that the reduced laser power requirement, in turn, promotes a smaller and lighter laser with an associated reduced Nominal Ocular Hazard Distance (NOHD) thereby increasing safety. NOHD is one generally-accepted criterion for assessing whether a laser is operating at a power level detrimental to human vision. The NOHD defines a near-range exposure danger zone for human vision. An additional benefit is that the filtered viewing system is naturally more covert as the reduced laser power is far less detectable as compared to one using an unfiltered system without the advantage of increased contrast.

Further, band-pass filter 800 can be used to increase the detection range of a laser 100 pointing a radiation beam 500 at a target 200 in daytime. As illustrated in FIG. 4, pointing lasers have a problem during daytime in that the spectrum of the laser irradiance 560 competes with ambient spectral irradiance from the sun 570. As a result, laser pointing in daytime becomes impractical because the large broadband irradiated power contribution of the sun overpowers the laser output. Therefore, very high power lasers would be needed for day pointing applications at useful distances.

In daylight, band-pass filter 800 will increase the effectiveness of a visible or NIR laser pointing system if the laser spot on target is brighter than the sun's contribution over the filtered band. The band-pass filter 800 should have as narrow a pass-band 850 as possible for compatibility with the pointing laser 100. For example, a diode pumped solid state (DPSS) laser emitting at 532 nm (green) has a narrow laser spectral-width, less than 1 nm, that does not change or drift over temperature. A pointing system with this green laser can use a correspondingly very narrow pass-band filter centered on or near 532 nm for this application. The narrower the filter pass-band (delta wavelength), the better the effective pointing distance for the same power laser

At night, band-pass filter 800 can be similarly used to enhance the detection of a laser pointer in the infrared wavelength regions. The band-pass filtering as illustrated in FIG. 4 continues to apply for use in a night time or dark environment where the broad spectrum of solar power would be replaced with a background of thermal power.

Continuing with FIG. 3, the input optic 600 focuses the filtered radiation onto a detector 620. The detector 620 or sensor materials could be silicon, germanium, cadmium, or any other suitable materials or combinations thereof. The detector 620 device could be fabricated from various materials into any one of a photo sensor, charged couple device (CCD), photo-multiplier tube (PMT), image intensifier, focal plane array (FPA), microbolometer, or other suitable radiation sensor.

The detector 620 can change the filtered radiation image into a plurality of electronic signals as a function of the incoming radiation. The electronic signals each corresponding to an individual image picture element or pixel. The electronics 640 can amplify and process the electronic signals from the detector 620. The electronics 640 can also include a gain control module. The gain control can be used to adjust the output of the electronic signals from the detector 620. The gain can be automatically controlled within the electronics to scale the electronic signals based on average energy detected, a detected peak, or any other criteria. Optionally, the gain can be manually controlled by a user to their preference.

An uncooled microbolometer focal plane array can be used as a thermal sensor, but is not limited thereto. The dynamic range of microbolometer sensors used in a LWIR viewer can be very large (˜10000:1). A band-pass filter 800 incorporated with such a detector could exploit the wide dynamic range to improve capability. A compatible band-pass filter 800 could use thin film technology on LWIR optical material to block a portion of the thermal radiant spectrum that includes the operational wavelength(s) of the viewing sensor. The improved viewer contrast would be proportional to the reduction of thermal power at the sensor from the band-pass filter. For example, an 8.2 to 8.6 um band-pass filter used in combination with an 8.3 um pointer could allow the user an improvement in contrast as “apparent” power and therefore increase visibility.

An image processor 660 can further process the electronic signals from the electronics 640 into a suitable format of data for transferring the scene image to an image output device 700. The image processor 660 can also perform pseudo-color rendering of the scene image, electronic filtering, anti-aliasing, dithering, data fusion, information overlay, or any other type of data manipulation.

The image processor 660 can also account for properties of the laser 100, band-pass filter 800, input optics 600, detector 620, electronics 640, and image output device 700 to optimize the electronic representation of the radiated image. For example, the image processor 660 can process the image based on laser 100 wavelength, band-pass filter 800 spectral characteristics, input optics 600 aberrations, detector 620 dynamic or spectral range, amplification factor of electronics 640, or any other electro-optic property of the laser viewing system components or combination thereof.

The output device 700 can be an electronic display, data signal transmission module, phosphor screen, night-vision imager, camera, recorder, storage media, or any other suitable device. An electronic display could be viewed by a person using the viewer. Alternatively, a data signal transmission module or camera could transmit the viewed scene to a remote location such as an operators work station, cockpit, command and control center, etc.

In accordance with another exemplary embodiment, improvement to visibility could be realized by moving band-pass filter 800, having a narrow transmission band, in and out of the optical path of the viewer 300. When the band-pass filter 800 is in the optical path, it could block nearly everything outside of the spectral range of interest except the reflected radiation beam 550 wavelength. By moving the band-pass filter 800 into and out of the optical path, a toggling between two images will result; one imaging including the target 200 irradiated by the radiated beam 500, the other including the target 200 and surrounding environment. This technique takes advantage of the human visual system's ability to integrate the two toggled images and view not only the target, but also the surrounding environment. Practically, the movement of the bandpass filter 200 in and out of the optical path at a certain frequency could allow a user to view a target 200 with a lower power radiation beam 500 that otherwise would not be possible.

It is also possible the two toggled images, one with the reflected radiation beam 550 and one with the target 200 and environment, could be combined in the electronics 640 or image processor 660 as one apparent scene before transmitted to the output 700. In this case, the integration of the two toggled images is performed by the electronics before passing to the output 700.

The toggling of the bandpass filter 800 can be performed manually by the user with a lever, handle, shutter, swivel, rotating filter, or with any other suitable means. The filter toggling function can also be electrically powered and automatic. The electrically powered toggling can be switched on or off by a user. The filter toggling function can also be switched between manual and automatic modes. The speed of the automatic toggling can be set by a user. Alternatively, the speed of the automatic toggling can be set by control electronics. A module incorporating the ability to move the band-pass filter 800 in and out of the reflected radiation 550 path could be added to viewer 300.

In still another exemplary embodiment, a clip-on band-pass filter 800 could be attached making it field deployable with viewer 300. For example, QCLs can be designed to any of several different laser wavelengths within the thermal region. By matching different QCL lasers with a band-pass filter at a corresponding spectral transmission range, highly covert thermal imaging systems could be deployed even if thermal detectors or microbolometers become readily available to those attempting to detect the use of a targeting thermal imaging system.

This electronic filtering could be further enhanced with very large amplification (high gain) for APD (avalanche photo-diode) arrays or PMT (photo-multiplier-tube) based viewing systems. This embodiment is useful for creating a covert viewing system that is undetectable without the customized viewer.

Either optical or electronic filtering can be used independently to extent range, or reduce size, weight, or power. In another embodiment, both optical and electronic filtering can be combined to create a low power pulsed laser system that is covert and undetectable except by the specific viewer.

In yet another exemplary embodiment, a linear polarizer could be used in place of the band-pass filter 800. A linear polarizer is an optical filter that passes light of a specific linear polarization. Thermal emissions from all objects, including reflections from an irradiated target and the nearby background, sometimes referred to as thermal signatures, are randomly polarized. This means radiated energy is made up of all possible polarizations. However, in most cases, laser radiation is linearly polarized and the laser radiation reflected from a target would also maintain much of the linear polarization.

A linear polarizer in the optical path before the input optics 600 would transmit only the linear polarization component parallel with the polarization of the laser radiation. This polarization technique would decrease random polarized light from background objects from reaching the detector 620 and increase the ratio of reflected laser radiation input at the viewer as compared to the background.

Fundamentally, purely random polarized radiation will be attenuated by about 50% when passing through a linear polarizer as a beam of unpolarized light can be thought of as containing a uniform mixture of linear polarizations at all possible angles with at least some portion of the light being transmitted. The same linear polarizer will pass nearly 100% of linear polarized radiation if the polarization angle of the polarizer is aligned correctly with the laser radiation reflected from the target for an ideal reflection free of depolarization. The net benefit of this contrast enhancement technique is a 2× increase in irradiance by the viewer (100%/50%=2×). This offers a significant advantage to reduce size, weight, and power for a laser viewing system. Such a linear polarizer could be aligned by a user either manually or automatically. In practice, some depolarization occurs making the net increase between 1×-2×.

One option for a linear polarizer is a wire-grid polarizer, which consists of a periodic array of fine parallel metallic wires, placed in a plane perpendicular to the reflected beam incident to the viewer. This is a very practical polarizer to implement in the LWIR region of interest with thermal imagery and a QCL-based laser pointer.

In yet another exemplary embodiment, a pulsing radiation beam 500 with a wavelength below the sensitive range of the detector 620 could be emitted from the laser 100. The reflected beam 550 is sensed by phase-locking the pulsed signal generated in the viewer 300 and from the reflected beam 550. Thereafter, electronic or imaging processing modules could extract the target information and format the image data prior to transmitting to the output 700. The advantage of optical filtering can be further enhanced if the laser 100 is modulated with a predetermined pulse sequence or frequency and electronic filtering is used at the viewer 300. This electronic filtering can detect a signal and amplify or add a mark on the visual scene for output.

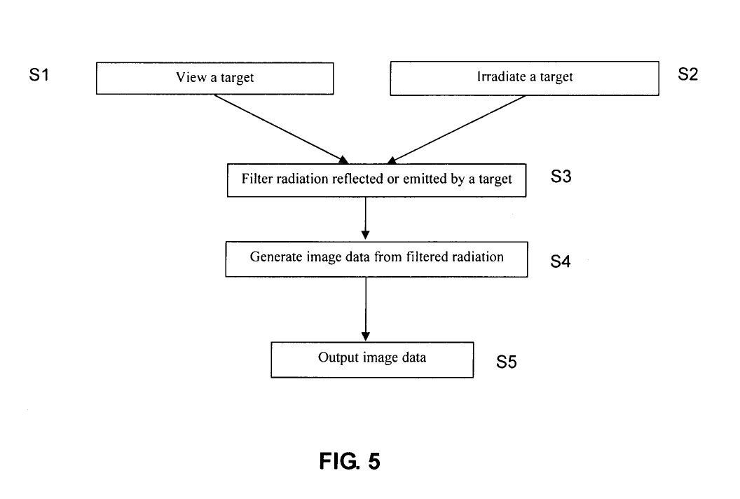

FIG. 5 is a flow chart illustrating a method of viewing an image using imaging system according to exemplary embodiments of the present invention. At step S1 a target or environment in which a potential target may exist is viewed using a viewer. At S2 the target or environment is irradiated with a beam by a laser. The target reflects at least a portion of the beam towards the viewer. Prior to entering the viewer, the reflected laser beam and the detected energy from the target and surrounding background are filtered by a band-pass filter in step S3. The band-pass filter transmits radiation at a wavelength of the laser beam and a portion of the spectrum emitted by the target and surrounding background.

The energy transmitted by the band-pass filter enters the viewer. At step S4 a detector converts the energy entering the viewer into electronic signals and generates image data. The image data is transmitted to an output at step S5.

It will be apparent to those skilled in the art that modifications and variations can be made in the present invention without departing from the spirit or scope of the invention. Thus, it is intended that the present disclosure cover the modifications and variations of this invention provided they come within the scope of the appended claims and their equivalents.

What is claimed is:

1. An imaging system comprising:
a filter configured to pass reflected laser radiation reflected from a target and to block radiation emitted from one or more objects in the target environment;
an input optic to accept and focus the reflected laser radiation passed by the filter;
a detector to receive the reflected laser radiation focused by the input optic and to convert the reflected radiation into a plurality of electronic signals;
an image processing module to process the electronic signals controlled by the electronic module into image data; and
an output device.

2. The imaging system of claim 1, further comprising a filter mechanism to move the filter in and out of an optical path of the reflected radiation.

3. The imaging system of claim 2, further comprising a control module to control the filter mechanism.

4. The imaging system of claim 1, wherein the filter is a bandpass filter.

5. The imaging system of claim 1, wherein the filter is a polarizer.

6. The imaging system of claim 5, wherein the polarizer is a wire grid polarizer.

7. The imaging system of claim 1, wherein the reflected radiation is infrared.

8. The imaging system of claim 7, wherein the laser is a quantum cascade laser.

9. The imaging system of claim 1, wherein the reflected radiation is pulsed.

10. The imaging system of claim 9, wherein the phase of the pulsed reflected radiation is sensed by phase-locking the pulsed signal generated in the viewer from the reflected radiation.

11. The imaging system of claim 1, wherein the detector is a microbolometer.

12. The imaging system of claim 1, further comprising a laser.

13. An imaging method comprising the steps of:
directing a viewer to a target that has been irradiated by a laser;
receiving reflected radiation reflected from and emitted by the target and the target environment;
filtering out a portion of the radiation received from the target and the target environment;
generating image data from the filtered radiation; and
outputting an image from the generated image data.

14. The imaging method of claim 13, further comprising moving the filter in and out of an optical path of the reflected radiation.

15. The imaging method of claim 13, wherein filtering including passing a portion of a spectral band of the radiation received from the target.

16. The imaging method of claim 13, wherein filtering includes polarizing the radiation received from the target.
